(19) United States
(12) Patent Application Publication
(10) Pub. No.: US 2003/0096646 A1
(43) Pub. Date: May 22, 2003

(54) Pari-Mutuel and equal opportunity gaming on a computer network

(76) Inventor: Ning Zhu, Miami, FL (US)

Correspondence Address: Ning Zhu, Apt. C302, 6757 SW 88 St., Miami, FL, 33156, US

(21) Appl. No.: 09/965,258

(22) Filed: Sep. 28, 2001

(51) Int. Cl. G06F 17/00

(52) U.S. Cl. 463/28

(57) ABSTRACT

This present invention provides an one hundred percent (100%) Pari-Mutuel method for wagering games played on a computer network system (including the Internet). It means that players in a game not only wager among themselves, but also share among themselves. The wagering games include casino table games (Twenty-One, Pai-Gow, etc.), and electronic games (slots, draw poker, Keno, Bingo and others), and other wagering games (Lottery, coin games). Players play a game together. No one else (including the house and players in other games) can disturb them. A pool is set up in the first play of the game. All players' wagers take the form of contributions to the pool. The payoff is the amount of shares instead of money. The winners will share the whole pool by their shares and then close the pool. This ensures all wagers are only redistributed among the players who made them. The present invention also further makes the pool progressive. In case there is no winner in a play of a game, the pool can carry over to the next play of the game.

This present invention also provides an equal opportunity method for said wagering games. In a play of a game, all players have equal hands or spin a slot machine together, so that they have equal opportunities to win.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The Internet has come, and it brings us a brand new way of communicating each other, and it also brings us a brand new way of playing games. Today, there are already hundreds of wagering games on the Internet. But most of them are still the copies of the traditional wagering games played in the old days including casino table games and electronic video games. They haven't used the advantages of the Internet.

Currently, wagering games on the Internet such as Twenty-One, Craps and Baccarat are played as house-banked games. Because of the disadvantages of the house-banked games, there are already new methods for the live casino table games and electronic video casino games. Some of them are Pari-Mutuel methods.

U.S. Pat. No. RE35,864 “Pari-Mutuel electronic and live table gaming” combines the Nevada style banked progressive with a Pari-Mutuel pool. However, it requires seeding by the house or banker, at startup and when the pool goes negative. Once house seeding is used, it is a banked game.

U.S. Pat. No. 5,984,779 “Continuous real time Pari-Mutuel method” provides a player pool without being banked (seeded) by the house. One hundred percent (100%) of player bets, less player winnings, goes to the player pool, not just a fraction of the bet. A top-prize feature insures that the pool won't drop back to the start-up condition of zero.

Both of the patents above use a pool, and the winner(s) take the prize from the pool instead of share the whole pool. Usually, there is still something left in the pool after a game. Then the pool can carry over to the next game or be shared by other games. That is also what the inventors expect. However, this is not fair for players who seed the pool. This is not a real “Pari-Mutuel”. Because the meaning of “Pari-Mutuel”, which is “a wager among ourselves”, should also means “share among ourselves”.

Furthermore, equal opportunity is a very important advantage of a wagering game. Most of wagering games, no matter where they're played, in a casino, a card room or a computer network; they still do not offer equal opportunities for players. Some equal opportunity wagering games are Lottery, Keno, etc. In a card game, for example, if all players have same hands, they have equal opportunities to win. It's impossible in most of traditional wagering games including casino table games, but it's possible now, on the Internet.

It is a feature of the present invention to program a wagering game to operate based on a real Pari-Mutuel wagering system so that all players play a game together, and they not only wager among themselves, but also share among themselves. This is one hundred percent (100%) Pari-Mutuel. This is really fair for the players who seed the pool.

It is a further feature of the present invention to make the pool, formed by the wagers, progressive in a game.

It is a feature of the present invention to program a wagering game to operate based on an equal opportunity system so that all players will have equal opportunities, for example: same poker hands, to win.

### BRIEF SUMMARY OF THE INVENTION

This present invention provides an one hundred percent (100%) Pari-Mutuel method for wagering games played on a computer network system (including the Internet). It means that players in a game not only wager among themselves, but also share among themselves. The wagering games include casino table games (Twenty-One, Pai-Gow, etc.), and electronic games (slots, draw poker, Keno, Bingo and others), and other wagering games (Lottery, coin games).

Players play a game together. No one else (including the house and players in other games) can disturb them. They will never give their money to someone else or leave their money in somewhere else after the game ends. A pool is set up in the first play of the game. New players are not allowed to join the game after the beginning of the game, and players in other games cannot share this pool, and the house does not seed the pool, nor take money from it. All players' wagers take the form of contributions to the pool and are not wagering against the house. The payoff is the amount of shares instead of money. The winners will share the whole pool by their shares and then close the pool. There is nothing left in the pool at the end of the game. This ensures all wagers are only redistributed among the players who made them.

It's not true that the winners always win the money. In other words, the prize is not always greater than the wager. It happens to the winner, who has a few shares, that the prize is less than the wager, i.e. the winner won the game but lost money, since other winner with many shares take a big part of the pool.

If there is no winner (draw or all lose), the wagers in the pool are returned to the players, and the pool is closed.

The present invention also further make said pool progressive. In case there is no winner in a play of a game, the pool can carry over to the next play of the game.

This present invention also provides an equal opportunity method for said wagering games. In a play of a game, all players have equal hands or spin a slot machine together, so that their opportunity should be equal. For example:

There are four players playing Twenty-One together. They have equal hand (same hand), so that they have equal opportunity to win. The differences among them are different decisions, some of them “Hit” and some of them “Stand”. That leads them to different way, win or lose.

### BRIEF DESCRIPTION OF THE SERVERAL VIEWS OF THE DRAWING

Not Applicable.

### DETAILED DESCRIPTION OF THE INVENTION

The followings are detailed description of the preferred embodiments. Some of them also show some gaming management methods. The unit of wager can be dollar, cent, etc. In some games, the rules may be modified.

Baccarat using progressive pool with a commission on winning “BAKNER”

The rules may be modified as follow:

There is no “TIE” selection.

The pool carries over to the next play on “TIE” result.

There are four players in this game: A, B, C and D.

On the beginning of the play, they put bets as follows:

A: 1 on “BANKER”;

B: 5 on “PLAYER”;

C: 2 on “BANKER”;

D: 3 on “PLAYER”.

So that the pool is: 1+5+2+3−11.

Then the result of the play is “TIE”, so there is no winner.

Then the pool carries over to the next play, and the players continue put bets as follows:

A: 2 on “BANKER”;

B: 4 on “PLAYER”;

C: 6 on “BANKER”;

D: 1 on “PLAYER”.

So that the pool is: 11 (pool)+2+4+6+1=24;

Then the result of the play is “BANKER” win, so

A: win;

B: loss;

C: win;

D: loss.

The winners, A and C, will share the pool;

A share: 2 Bets×1 Payoffs=2 Shares;

C share: 6 Bets×1 Payoffs=6 Shares;

The share total is 2+6=8.

Share value=24(pool)/8(Share total)=3

A get: 2(Shares)×3(Share value)=6

C get: 6(Shares)×3(Share value)=18

Then they pay 5% commission since they win on “BANKER”.

Caribbean Stud. RTM. poker using pool with commission withheld from wagers

The rules may be modified as follow:

There is no bonus.

The commission is 3%.

The payoffs are as follow:

| Hands | Payoffs |
|---|---|
| One Pair | 1 to 1 |
| Two Pairs | 2 to 1 |
| Three of a Kind | 3 to 1 |
| Straight | 4 to 1 |
| Flush | 5 to 1 |
| Full House | 7 to 1 |
| Four of a Kind | 20 to 1 |
| Straight Flush | 50 to 1 |
| Royal Flush | 200 to 1 |

There are four players in this game: A, B, C and D;

On the beginning of the play, every one put 1 ante into the pool;

So that the pool is: 1×4=4;

Then every one receives five cards face down and the dealer receives five cards with four cards face down and one card face up;

Then all players look at their cards and put bets as follows:

A: 2.06;

B: 4.12;

C: 0;

D: 1.03.

Then pay 3% commission, and put the bets to pool as follows:

A: 2;

B: 4;

C: 0;

D: 1.

So that the pool is: 4 (ante)+2+4+0+1 =11;

If the result of the play is:

A: loss;

B: win with hand “Straight”;

C: loss;

D: win with hand “One Pair”;

The winners, B and D, will share the pool;

B share: 2 Bets×4 Payoffs=8 Shares;

D share: 1 Bets×1 Payoffs=1 Share;

The share total is 8+1=9.

Share value=11(pool)/9(Share total)=1.222.

B get: 8(Shares)×1.222 (Share value)=9.78;

D get: 1(Shares)×1.222 (Share value)=1.22.

Caribbean Stud. RTM. poker using pool and equal opportunity

The rules may be modified as follow:

All payoffs are 1 to 1.

There are four players in this game: A, B, C and D.

Everyone put 5 as ante, so that the pool is: 5×4=20;

Then A receives five cards: A—spade, 8—heart, 3—diamond, Q—spade, 5—club and B, C and D receive the copy of A's cards respectively, so that their hands are also: A—spade, 8—heart, 3—diamond, Q—spade, 5—club, and the dealer receives five cards with four cards face down and one card face up;

Then all players look at their cards and put bets as follows:

A: 2;

B: 4;

C: 0;

D: 1.

So that the pool is: 20 (ante)+2+4+0+1=27.

Since their hands are equal, so that they will be winner or loser together.

If the result of the play is all win: They will share the pool;

A share: 2 Bets×1 Payoffs=2 Shares;

B share: 4 Bets×1 Payoffs=4 Shares;

C share: 0 Bets×1 Payoffs=0 Shares;

D share: 1 Bets×1 Payoffs=1 Share;

The share total is 2+4+0+1=7.

Share value=27(pool)/7(Share total)=3.857.

A get: 2(Shares)×3.857 (Share value)=7.71;

B get: 4(Shares)×3.857 (Share value)=15.43;

C get: 0(Shares)×3.857 (Share value)=0;

D get: 1(Shares)×3.857 (Share value)=3.86.

In-Between Poker (Ace-Deuce) using pool with commission on player

A lot of online casinos provide this game with name “Red Dog”.

The payoffs are as follow:

| Spread | Payoffs |
|---|---|
| 1 | 5 to 1 |
| 2 | 4 to 1 |
| 3 | 2 to 1 |
| 4-11 | 1 to 1 |

There are four players in this game: A, B, C and D.

All players pay one dollar commission before playing game.

On the beginning of the play, they put bets as follows:

A: 2;

B: 4;

C: 6;

D: 1.

So that the pool is: 2+4+6+1=13;

Then every one receives two cards;

All players look at their cards and they play as follow:

A: select “STAND”;

B: select “RAISE”;

C: select “STAND”;

D: select “RAISE”.

Since B and D select “RAISE”, so their wagers will be:

B wager: 4×2=8

D wager: 1×2=2

The pool will be: 2+8+6+2=18;

If the result of the play is:

A: loss;

B: win with spread 8;

C: loss;

D: win with spread 1.

The winners, B and D, will share the pool;

B share: 8 Bets×1 Payoffs=8 Shares;

D share: 2 Bets×5 Payoffs=10 Share;

The share total is 8+10=18.

Share value=18(pool)/18(Share total)=1.

B get: 8(Shares)×1 (Share value)=8;

D get: 10(Shares)×1 (Share value)=10.

In-Between Poker (Ace-Deuce) using pool and equal opportunity

A lot of online casinos provide this game with name “Red Dog”.

The rules may be modified as follow:

Need ante.

All payoffs are 1 to 1.

There are four players in this game: A, B, C and D.

Each of them put 5 as ante, so that the pool is: 5×4=20.

On the beginning of the play, they put bets as follows:

A: 2;

B: 4;

C: 6;

D: 1.

So that the pool is: 20 (ante)+2+4+6+1=33;

Then A receives two cards: A—spade, 8—heart;

B, C and D receive the copy of A's cards respectively, so that their hands are also: A—spade, 8—heart.

All players look at their cards and they play as follow:

A: select “STAND”;

B: select “RAISE”;

C: select “STAND”;

D: select “RAISE”.

Since B and D select “RAISE”, so their wagers will be:

B wager: 4×2=8

D wager: 1×2=2

The pool will be: 20 (ante)+2+8+6+2=38.

Since their hands are equal, so that they will be winner or loser together.

If the result of the play is all win: They will share the pool;

A share: 8 Bets×1 Payoffs=8 Shares;

B share: 4 Bets×1 Payoffs=4 Shares;

C share: 6 Bets×1 Payoffs=6 Shares;

D share: 2 Bets×1 Payoffs=2 Share;

The share total is 8+4+6+2=20.

Share value=38(pool)/20(Share total)=1.9.

A get: 2(Shares)×1.9 (Share value)=3.8;

B get: 8(Shares)×1.9 (Share value)=15.2;

C get: 6(Shares)×1.9 (Share value)=11.4;

D get: 2(Shares)×1.9 (Share value)=3.8.

Pai-Gow Poker using pool and equal opportunity

There are four players in this game: A, B, C and D.

Each of them put 5 as ante so that the pool is: 5×4=20;

On the beginning of the play, they put bets as follows:

A: 2;

B: 4;

C: 6;

D: 1.

So that the pool is: 2+4+6+1=13;

Then A receives seven cards: A—spade, 8—heart, 2—club, K—heart, 5—club, 3—spade, 8—heart, and

B, C and D receive the copy of A's cards respectively, so that their hands are also: A—spade, 8—heart, 2—club, K—heart, 5—club, 3—spade, 8—heart, and the dealer receives seven cards face down.

All player form his seven cards to two hands.

If the result of the play is:

A: loss;

B: win;

C: loss;

D: win.

The winners, B and D, will share the pool;

B share: 4 Bets×1 Payoffs=4 Shares;

D share: 1 Bets×1 Payoffs=1 Share;

The share total is 4+1=5.

Share value=13(pool)/5(Share total)=2.6.

B get: 4(Shares)×2.6 (Share value)=10.4;

D get: 1(Shares)×2.6 (Share value)=2.6.

Red Dog using pool and equal opportunity

A lot of online casinos provide “In-Between Poker” (Ace-Deuce) games with name “Red Dog”.

The payoff is one to one, i.e. the share is equal to the wagers.

There are four players in this game: A, B, C and D.

Everyone put 5 as ante so that the pool is: 5×4=20;

Then A receives five cards: A—spade, 8—heart, 3—diamond, Q—spade, 5—club and B, C and D receive the copy of A's cards respectively, so that their hands are also: A—spade, 8—heart, 3—diamond, Q—spade, 5—club.

Then all players look at their cards and put bets as follows:

A: 2;

B: 4;

C: 0;

D: 1.

So that the pool is: 20 (ante)+2+4+0+1=27;

Then the dealer turn up the top card on a deck.

Since their hands are equal, so that they will be winner or loser together.

If the result of the play is all win: They will share the pool;

A share: 2 Bets×1 Payoffs=2 Shares;

B share: 4 Bets×1 Payoffs=4 Shares;

C share: 0 Bets×1 Payoffs=0 Shares;

D share: 1 Bets×1 Payoffs=1 Share;

The share total is 2+4+0+1=7.

Share value=27(pool)/7(Share total)=3.857.

A get: 2(Shares)×3.857 (Share value)=7.71;

B get: 4(Shares)×3.857 (Share value)=15.43;

C get: 0(Shares)×3.857 (Share value)=0;

D get: 1(Shares)×3.857 (Share value)=3.86.

Slot Machine using pool and equal opportunity

In this machine, all player spin it together, so that's equal opportunity.

The payoffs are as follow:

| | |
|---|---|
| One 7 and any | 1 to 1 |
| Two Strawberries and any | 2 to 1 |
| One 7 and two Strawberries | 9 to 1 |
| Two 7 and one Strawberry | 25 to 1 |
| Three Strawberries | 50 to 1 |
| Three 7 | 250 to 1 |

There are four players in this game: A, B, C and D.

On the beginning of the play, they put bets as follows:

A: 2 on “One 7 and two Strawberries”;

B: 4 on “Three Strawberries”;

C: 6 on “One 7 and any”;

D: 1 on “Two Strawberries and any”.

So that the pool is: 2+4+6+1=13.

Then this slot machine spins and stops at: “One 7 and two Strawberries. So the result of the play is:

A: win;

B: loss;

C: win;

D: loss.

The winners, A and C, will share the pool;

A share: 2 Bets×9 Payoffs=18 Shares;

C share: 6 Bets×1 Payoffs=6 Share;

The share total is 18+6=24.

Share value=13(pool)/24(Share total)=0.542.

B get: 18(Shares)×0.542 (Share value)=9.75;

D get: 6(Shares)×0.542 (Share value)=3.25.

Twenty-One using pool and equal opportunity

The payoff is one to one, i.e. the share is equal to the wagers.

There are four players in this game: A, B, C and D.

On the beginning of the play, they put bets as follows:

A: 2;

B: 4;

C: 6;

D: 1.

So that the pool is: 2+4+6+1=13;

Then A receives two cards: 9—spade, 8—heart, and B, C and D receive the copy of A's cards respectively, so that their hands are also: 9—spade, 8—heart, and the dealer receives two cards with first card face up and the second card face down.

Then they play as follow:

A: select “Stand”;

B: select “Hit” then “Double”;

C: select “Hit”, “Hit” then “Stand”;

D: select “Hit” then “Stand”.

Since B selects “Double”, so his wagers will be 4×2=8. The pool will be: 2+4×2+6+1=17;

If the result of the play is:

A: loss;

B: win;

C: loss;

D: win.

The winners, B and D, will share the pool;

B share: 8 Bets×1 Payoffs=8 Shares;

D share: 1 Bets×1 Payoffs=1 Share;

The share total is 8+1=9.

Share value=17(pool)/9(Share total)=1.89.

B get: 8(Shares)×1.89 (Share value)=15.11;

D get: 1(Shares)×1.89 (Share value)=1.89.

If the result of the play is all win, all players will share the pool;

A share: 2 Bets×1 Payoffs=2 Shares;

B share: 8 Bets×1 Payoffs=8 Shares;

D share: 6 Bets×1 Payoffs=6 Share;

D share: 1 Bets×1 Payoffs=1 Share;

The share total is 2+8+6+1=17.

Share value=17(pool)/17(Share total)=1.

A get: 2(Shares)×1 (Share value)=2;

B get: 8(Shares)×1 (Share value)=8;

C get: 6(Shares)×1 (Share value)=6;

D get: 1(Shares)×1 (Share value)=1.

They just got their wagers back.

Video Poker using pool and equal opportunity

The payoffs are as follow:

| Hands | Payoffs |
|---|---|
| Jacks or Better | 1 to 1 |
| Two Pairs | 2 to 1 |
| Three of a Kind | 3 to 1 |
| Straight | 4 to 1 |
| Flush | 6 to 1 |
| Full House | 9 to 1 |
| Four of a Kind | 25 to 1 |

| | |
|---|---|
| Straight Flush | 50 to 1 |
| Royal Flush | 250 to 1 |

There are four players in this game: A, B, C and D.

On the beginning of the play, they put bets as follows:

A: 2;

B: 4;

C: 6;

D: 1.

So that the pool is: 2+4+6+1=13;

Then A receives five cards: 2—spade, 8—heart, 3—diamond, Q—spade, J—diamond, and B, C and D receive the copy of A's cards respectively, so that their hands are also: 2—spade, 8—heart, 3—diamond, Q—spade, J—diamond;

Then all players look at their cards and select their hold cards as follows:

| Player | 1^{st} Card | 2nd Card | 3rd Card | 4th Card | 5th Card |
|---|---|---|---|---|---|
| A | Hold | | Hold | | |
| B | | | | Hold | |
| C | Hold | | Hold | | |
| D | | | | | Hold |

Then B receives a card “A—spade” for replacing the first card in the hand, and all other players who did not select the first card in hand to hold, D only, receive the copy of the “A—spade”, so that they all replace their first card with the “A—spade”.

Then A receives a card “J—heart” for replacing the second card in the hand, and all other players who did not select the second card in hand to hold, B, C and D, receive the copy of the “J—heart”, so that they all replace their second card with the “J—heart”.

Then B receives a card “10—club” for replacing the third card in the hand, and all other players who did not select the third card in hand to hold, D only, receive the copy of the “10—club”, so that they all replace their third card with the “10—club”.

Then A receives a card “3—spade” for replacing the fourth card in the hand, and all other players who did not select the fourth card in hand to hold, C and D, receive the copy of the “3—spade”, so that they all replace their third card with the “3—spade”.

Then A receives a card “K—diamond” for replacing the fifth card in the hand, and all other players who did not select the fifth card in hand to hold, B and C , receive the copy of the “K—diamond”, so that they all replace their third card with the “K—diamond”.

Then all players' hands are as follows:

| Player | 1st Card | 2nd Card | 3rd Card | 4th Card | 5th Card |
|---|---|---|---|---|---|
| A | 2-spade | J-heart | 3-diamond | 3-spade | K-diamond |
| B | A-spade | J-heart | 10-club | Q-spade | K-diamond |
| C | 2-spade | J-heart | 3-diamond | 3-spade | K-diamond |
| D | A-spade | J-heart | 10-club | 3-spade | J-diamond |

The result of the play is:

A: loss;

B: win with hand “Straight”;

C: loss;

D: win with hand “Jacks or Better”;

The winners, B and D, will share the pool;

B share: 2 Bets×4 Payoffs=8 Shares;

D share: 1 Bets×1 Payoffs=1 Share;

The share total is 8+1=9.

Share value=11(pool)/9(Share total)=1.222.

B get: 8(Shares)×1.222 (Share value)=9.78;

D get: 1(Shares)×1.222 (Share value)=1.22.

We claim:

1. A method of playing a wagering game on a computer network system that may include the Internet, and there are at least two players playing said game together, comprising:
a) excluding new player from joining said game after the beginning of said game, and until the said game ends;
b) creating a pool for said game with a value of zero in the first play of said game;
c) excluding players in other games from sharing said pool,
d) contributing wagers to said pool by all players in said play;
e) determining the winners in said play;
f) determining the shares for each of said winners by predetermined payoff amount;
g) said winners sharing the whole pool by
setting the total shares equal to the sum of said shares of said winners,
then setting the share value equal to said pool divided by said total shares, and
then setting the prize for each of said winners equal to said share value multiplied by the shares of said winner, and
then said winner taking said prize from said pool.

2. The method of claim 1 in which the wagering game is Twenty-One and the predetermined payoff amount is based on conventional Twenty-One winning combinations.

3. The method of claim 1 in which the wagering game is Pai-Gow poker and the predetermined payoff amount is based on conventional Pai-Gow winning combinations.

4. The method of claim 1 in which the wagering game is Caribbean Stud. RTM. poker and the predetermined payoff amount is based on conventional Caribbean Stud. RTM. poker winning combinations.

5. The method of claim 1 in which the wagering game is Red Dog poker and the predetermined payoff amount is based on conventional Red Dog poker winning combinations.

6. The method of claim 1 in which the wagering game is selected from the group consisting of Twenty-One, Craps, Baccarat, Pai-Gow poker, Jacks-or-Better, Roulette, Let It Ride! RTM., Caribbean Stud. RTM. poker, Red Dog poker, In-Between poker, Free Ride poker, slot machine, electronic Video Poker, electronic Twenty-One, electronic Keno and electronic Craps.

7. The method of claim 1 in which the wagering game is a card game and the predetermined payoff amount is based on conventional winning combinations for the card game.

8. The method of claim 1 in which the wagering game is a dice game and the predetermined payoff amount is based on conventional winning combinations for the dice game.

9. The method of claim 1 in which if there is no winner, said pool will carry over to the next play of said game.

10. A method of playing a wagering game on a computer network system that may include the Internet, and there are at least two players playing said game together, and in each play of said game, said players have equal opportunity to win before they making any decision affecting said opportunity.

11. The method of claim 10 in which the players who made same decisions that affecting winning opportunity of said players will have equal opportunity to win.

12. The method of claim 11 in which the wagering game is selected from the group consisting of Twenty-One, Craps, Baccarat, Pai-Gow poker, Jacks-or-Better, Roulette, Let It Ride! RTM., Caribbean Stud. RTM. poker, Red Dog poker, In-Between poker, Free Ride poker, slot machine, electronic Video Poker, electronic Twenty-One, electronic Keno and electronic Craps.

13. The method of claim 10 in which the wagering game is a card game using actual or electronically generated representations of standard cards further comprising:
a) drawing predetermined number of cards, and for each of said cards, providing one from the group consisting of actual, copy and electronically generated representation of said card to players.

14. The method of claim 13 in which the card game is Caribbean Stud. RTM. poker, and said predetermined number of cards is 5, and further comprising providing five cards to the dealer with four cards face up and one card face down.

15. The method of claim 13 in which the card game is In-Between poker, and said predetermined number of cards is 2.

16. The method of claim 13 in which the card game is Pai-Gow poker, and said predetermined number of cards is 7, and further comprising:
b) providing seven cards face down to the dealer;
c) players using their seven cards forming 2 hands, one with 5 cards and the other with 2 cards.

17. The method of claim 13 in which the card game is Red Dog, and said predetermined number of cards is 5.

18. The method of claim 13 in which the card game is Twenty-One, and said predetermined number of cards is 2, and further comprising the steps of:
b) providing two cards to the dealer with one cards face up and one card face down;
c) giving the players the choice of “Stand”, “Hit” or “Double”;
d) providing one card to the players, who select “Hit” or “Double”, by drawing one card, then providing one from the group consisting of actual, copy and electronically generated representation of said card to said players.

19. The method of claim 13 in which the wagering game is Video Poker, and said predetermined number of cards is 5, and further comprising the steps of:
b) giving the players the chance to inspect the cards that player received, and the choice of cards to hold;
c) providing cards to players, who did not select the first card in hand to hold, to replace their first card by drawing one card, then providing one from the group consisting of actual, copy and electronically generated representation of said card to said players;
d) providing cards to players, who did not select the second card in hand to hold, to replace their second card by drawing one card, then providing one from the group consisting of actual, copy and electronically generated representation of said card to said players;
e) providing cards to players, who did not select the third card in hand to hold, to replace their third card by drawing one card, then providing one from the group consisting of actual, copy and electronically generated representation of said card to said players;
f) providing cards to players, who did not select the fourth card in hand to hold, to replace their fourth card by drawing one card, then providing one from the group consisting of actual, copy and electronically generated representation of said card to said players;
g) providing cards to players, who did not select the fifth card in hand to hold, to replace their fifth card by drawing one card, then providing one from the group consisting of actual, copy and electronically generated representation of said card to said players.

20. The method of claim 10 in which the wagering game is slot machine game, and further comprising the steps of:
a) all players spinning one machine together;
b) said players getting same result of said spinning.
